(19) United States
(12) Patent Application Publication
(10) Pub. No.: US 2006/0155438 A1
(43) Pub. Date: Jul. 13, 2006

(54) Data storage system

(76) Inventors: Daisuke Tsunoda, Kanagawa (JP); Yuichi Takayanagi, Kanagawa (JP); Akihiro Morimoto, Kanagawa (JP); Kenji Mori, Aichi (JP)

Correspondence Address: RATNERPRESTIA, P O BOX 980, VALLEY FORGE, PA, 19482-0980, US

(21) Appl. No.: 10/531,623

(22) PCT Filed: Oct. 16, 2003
(86) PCT No.: PCT/JP03/13290

§ 371 Date: Nov. 29, 2005

(30) Foreign Application Priority Data
Oct. 18, 2002 (JP) 2002-304371

(51) Int. Cl. G06F 17/00

(52) U.S. Cl. 701/35; 701/1

(57) ABSTRACT

A data storage system comprises a temporary cache for temporarily storing data, a permanent cache for storing data for a predetermined period, and a memory selector for selectively having the temporary cache and the permanent cache store the data received by a terminal communicator. A data sorter sorts the data into temporary cache data to be stored in the temporary cache and permanent cache data to be stored in the permanent cache. In this way, it may be unnecessary to confirm whether or not the permanent cache data is updated in the permanent cache may be eliminated.

### TECHNICAL FIELD OF THE INVENTION

The present invention relates to a data storage system, and more particularly to a data storage system for storing data transmitted from an information center in a terminal provided in an automotive vehicle.

### DESCRIPTION OF THE RELATED ART

Up until now, there have been provided a wide variety of prior-art data storage systems. One typical example of the conventionally known data storage system of this type is disclosed in, for example, Japanese Patent Laid-Open Publication No. 2002-109686 (pages 4 to 5, FIG. 1). The conventional data storage system herein disclosed comprises a server computer having stored therein information data and a client computer for receiving the information data from the server computer, and the client computer includes a cache memory for temporarily storing therein the information data obtained from the server computer. The conventional data storage system thus constructed can curtail a communication period taken for the client computer to communicate with the server computer because of the fact that the client computer may refer to the information data already stored in the cache memory in the event that the client computer is required to obtain the information data stored in the server computer. The conventional data storage system as previously mentioned, however, encounters such a drawback that the information data stored in the server computer may be updated after the information data is transmitted to the client computer and temporarily stored in the cache memory forming part of the client computer. This leads to the fact that the client computer is required to unremittedly communicate with the server computer and confirm whether or not the information data stored in the server computer has been updated after the information data is transmitted to the client computer and temporarily stored in the cache memory forming part of the client computer, thereby increasing communication period and thus communication cost.

The present invention is made for the purpose of overcoming the above mentioned drawback, and it is therefore an object of the present invention to provide a data storage system which can eliminate the need of confirming whether or not the information data stored in the server computer has been updated, thereby reducing communication period and thus communication cost.

### DISCLOSURE OF THE INVENTION

In accordance with a first aspect of the present invention, there is provided a data storage system, comprising: a vehicle-mounted terminal mounted on an automotive vehicle; and an information center for transmitting data to the vehicle-mounted terminal in response to a request from the vehicle-mounted terminal, and in which the vehicle-mounted terminal includes terminal communicating means for communicating with the information center, temporary cache means for temporarily storing therein the data, permanent cache means for storing therein the data for a predetermined period, and memory selecting means for selectively having the temporary cache means and the permanent cache means store therein the data received by the terminal communicating means, and the information center includes center communicating means for communicating with the vehicle-mounted terminal, and data sorting means for sorting the data into temporary cache data to be stored in the temporary cache means and permanent cache data to be stored in the permanent cache means.

In accordance with the above construction, the data storage system according to the present invention can eliminates the need of confirming whether or not the data stored in the permanent cache means is updated when the data stored in the permanent cache means is required to be referred to resulting from the fact that the data sorting means is operative to sort the data into temporary cache data to be stored in the temporary cache means of the vehicle-mounted terminal and permanent cache data to be stored in the permanent cache means of the vehicle-mounted terminal. This leads to the fact that the data storage system according to the present invention thus constructed can reduce a communication period and thus communication cost.

In the aforementioned data storage system according to the present invention, the terminal communicating means may be operative to receive a data sorting index while receiving the data from the information center, and the memory selecting means may be operative to selectively have the temporary cache means and the permanent cache means store therein the data received by the terminal communicating means on the basis of the data sorting index.

In accordance with the above construction, the data storage system according to the present invention ensures to sort the data into the temporary storage data and the permanent storage data resulting from the fact that the memory selecting means is operative to selectively have the temporary cache means and the permanent cache means store therein the data received by the terminal communicating means on the basis of the data sorting index.

In the aforementioned data storage system according to the present invention, the information center may further include available space obtaining means for obtaining a storage space available in the permanent cache means.

In accordance with the above construction, the data storage system according to the present invention makes it possible for the information center to obtain a storage space available in the permanent cache means.

In the aforementioned data storage system according to the present invention, the information center may further include data deletion means for deleting the permanent cache data stored in the permanent cache means.

In accordance with the above construction, the data storage system according to the present invention makes it possible for the information center to delete the data stored in the permanent cache means in the event that there is an insufficient storage space available in the permanent cache means.

In accordance with a second aspect of the present invention, there is provided a vehicle-mounted terminal according to the present invention mounted on an automotive vehicle, comprising: terminal communicating means for communicating with an information center operative to transmit data, temporary cache means for temporarily storing therein the data, permanent cache means for storing therein the data for a predetermined period, and memory selecting means for selectively having the temporary cache means and the permanent cache means store therein the data.

In accordance with the above construction, the vehicle-mounted terminal accordance to the present invention can sort the data into the temporary cache data and the permanent cache data resulting from the fact that the memory selecting means is operative to selectively have the temporary cache means and the permanent cache means store therein the data received from the information center.

In accordance with a third aspect of the present invention, there is provided an information center comprising: center communicating means for transmitting data to a vehicle-mounted terminal in response to a request from the vehicle-mounted terminal; and data sorting means for sorting the data into temporary cache data to be temporarily stored in the vehicle-mounted terminal and permanent cache data to be stored for a predetermined period in the vehicle-mounted terminal.

In accordance with the above construction, the information center according to the present invention can manage the data sorted into the temporary cache data and the permanent cache data resulting from the fact that the data sorting means is operative to sort the data into the temporary cache data to be temporarily stored in the vehicle-mounted terminal and the permanent cache data to be stored for a predetermined period in the vehicle-mounted terminal.

In accordance with a fourth aspect of the present invention, there is provided a data storage method, comprising: a data sorting step of sorting data into temporary cache data to be temporarily stored and permanent cache data to be stored for a predetermined period; a temporary storing step of temporarily storing therein the temporary cache data; and a permanent storing step of storing therein the permanent cache data.

In accordance with the above method, the data can be sorted into the temporary cache data and the permanent cache data in the data sorting step.

The aforementioned data storage method may further comprise an available space obtaining step of obtaining a storage space available in permanent cache means operative to store therein the permanent cache data.

In accordance with the above method, the storage space available in the permanent cache means operative to store therein the permanent cache data can obtained in the available space obtaining step.

The aforementioned data storage method may further comprise a data deleting step of deleting the permanent cache data stored in the permanent storing step.

In accordance with the above method, the permanent cache data stored in the permanent storing step can be deleted in the data deleting step.

### BRIEF DESCRIPTION OF THE DRAWINGS

The features and advantages of a data storage system according to the present invention will be more clearly understood from the following description taken in conjunction with the accompanying drawings in which:

FIG. 1 is a block diagram showing a preferred embodiment of the data storage system according to the present invention;

FIG. 2 is a block diagram showing an example of contents data structurally stored in the data storage system shown in FIG. 1;

FIG. 3 is a block diagram showing an example of data sorted by the data storage system shown in FIG. 1;

FIG. 4 is a block diagram showing an example of contents displayed by the data storage system shown in FIG. 1;

FIG. 5 is a flowchart showing a flow of a data sorting operation performed by the data storage system shown in FIG. 1;

FIG. 6 is a flowchart showing a flow of an operation performed by the data storage system shown in FIG. 1 when contents are requested;

FIG. 7 is a flowchart showing a flow of a temporary cache data confirming operation performed by the data storage system shown in FIG. 1; and

FIG. 8 is a flowchart showing a flow of a data storage operation performed by the data storage system shown in FIG. 1.

### DESCRIPTION OF THE PREFERRED EMBODIMENTS

A preferred embodiment of the present invention will be described hereinafter with reference to the drawings.

The construction of the preferred embodiment of a data storage system according to the present invention will be described first.

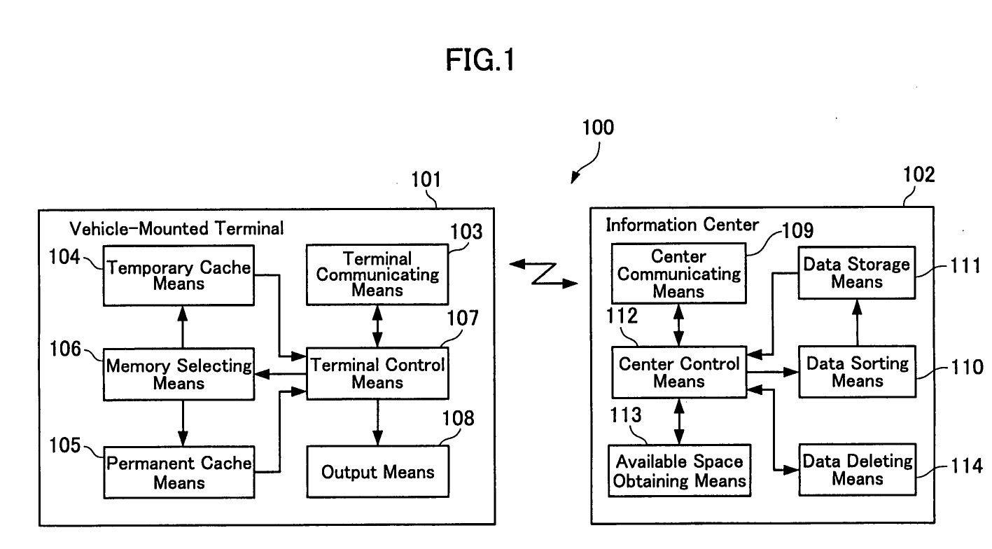

Referring to FIG. 1 of the drawings, there is shown a data storage system 100, comprising a vehicle-mounted terminal 101 mounted on an automotive vehicle and an information center 102 for transmitting data to the vehicle-mounted terminal 101 in response to a request from the vehicle-mounted terminal 101.

The vehicle-mounted terminal 101 comprises terminal communicating means 103 for communicating with the information center 102, temporary cache means 104 for temporarily storing therein data, permanent cache means 105 for storing therein data for a predetermined period, memory selecting means 106 for selectively having the temporary cache means 104 and the permanent cache means 105 store therein the data received by the terminal communicating means 103, terminal control means 107 for controlling the whole operations of the vehicle-mounted terminal 101, and output means 108 for outputting an image and a sound therethrough.

The information center 102 comprises center communicating means 109 for communicating with the vehicle-mounted terminal 101, data sorting means 110 for sorting data into temporary cache data to be stored in the temporary cache means 104 and permanent cache data to be stored in the permanent cache means 105, data storage means 111 for respectively storing therein the temporary cache data and the permanent cache data sorted by the data sorting means 110, center control means 112 for controlling the whole operations of the information center 102, available space obtaining means 113 for obtaining a storage space available in the permanent cache means 105, and data deletion means 114 for deleting the permanent cache data stored in the permanent cache means 105.

The vehicle-mounted terminal 101 and the information center 102 are connected with, for example, the Internet respectively through the terminal communicating means 103 and the center communicating means 109. The information center 102 is operative to transmit contents data such as, for example, text data, graphic data, and the like, to the vehicle-mounted terminal 101 in response to a request from the vehicle-mounted terminal 101. The information center 102 may be connected with contents delivery apparatus, not shown, exterior of the information center 102, or further comprise data inputting means, not shown, for receiving contents data from the exterior thereof. Further, the vehicle-mounted terminal 101 and the information center 102 are designed to transmit data to and receive data from each other in conformance with a communications protocol, for example, TCP/IP (Transmission Control Protocol/Internet Protocol), UUCP (Unix™ to Unix™ Copy Protocol), or the like. According to the present invention, the vehicle-mounted terminal 101 and the information center 102 may be connected with each other without the Internet and transmit data to and receive data from each other in conformance with their original communications protocol.

The memory selecting means 106, the terminal control means 107, the data sorting means 110, the center control means 112, the available space obtaining means 113, and the data deletion means 114 are constituted by, for example, CPU (Central Processing Unit), RAM (Random Access Memory), ROM (Read Only Memory), and the like.

The temporary cache means 104 and the permanent cache means 105 are constituted by, for example, semiconductor memories so that the temporary cache means 104 and the permanent cache means 105 can read out data therefrom and store data thereinto at high speed. The temporary cache means 104 is adapted to store data temporarily therein. In the case that the temporary cache means 104 is required to store therein a new piece of data while the temporary cache means 104 has an insufficient storage space, the terminal control means 107 is operative to delete the other one or more pieces of data from the temporary cache means 104 in order of the length of time the pieces of data have been therein stored, viz., early order of the pieces of data to ensure a sufficient storage space in the temporary cache means 104. The temporary cache means 104 may be designed to delete the data therefrom whenever the vehicle-mounted terminal 101 is powered off. Here, the word “temporarily storing data” appearing herein is intended to mean an operation of storing data for a period from the time when the data is stored in the temporary cache means 104 until the data is deleted from the temporary cache means 104.

On the contrary, the permanent cache means 105 is adapted to store therein data for a predetermined period. Here, the word “predetermined period” appearing herein is intended to mean a period starting from the time when the data is stored in the permanent cache means 105 until the data is overwritten in the permanent cache means 105 or the data is deleted from the permanent cache means 105 by the data deletion means 114. The permanent cache means 105 is designed to preserve the data stored therein regardless of whether or not the vehicle-mounted terminal 101 is powered off.

The output means 108 is constituted by, for example, an image display unit for displaying an image and a sound output unit for outputting a sound therethrough. The image display unit includes, for example, an image data buffer memory, an image signal processing circuit, and an LCD (liquid crystal display), and adapted to display, for example, characters, symbols, still images, and moving images. The sound output unit includes, for example, a sound signal buffer memory, a sound signal amplifying circuit, and a speaker, and adapted to output therethrough, for example, voices, music, and sound effects.

The data sorting means 110 is designed to sort the data obtained in the information center 102 into temporary cache data to be stored in the temporary cache means 104 and permanent cache data to be stored in the permanent cache means 105. The data sorting means 110 may include an input unit such as, for example, a key board, a joystick, or the like, an image display unit for displaying an image, and a sound output unit for outputting a sound therethrough, and an operator of the information center 102 may judge whether or not the data is likely to be updated while observing the data displayed by the display unit with the sound outputted through the sound output unit, and operate the input unit to sort the data into the temporary cache data when the operator judges that the data is likely to be updated and the permanent cache data when the operator judges that the data is unlikely to be updated. In addition, the data sorting means 110 may include a sort-learning unit for learning how the operator has sorted the data to make a sorting database, and the data sorting means 110 may sort the data into the temporary cache data and the permanent cache data on the basis of the sorting database thus made by the sort-learning unit. Further, the data sorting means 110 may sort the data into the temporary cache data and the permanent cache data on the basis of an extension of the data such as, for example, TXT, DOC, or the like. The data sorting means 110 is operative to generate data sorting information as a result of the sorting operations and the data storage means 111 is operative to store therein the data sorting information. The data sorting information includes the temporary cache data and the permanent cache data sorted by the data sorting means 110 and a table indicative of the temporary cache data and the permanent cache data, hereinlater simply referred to as “data sorting table”. The data sorting table is described with a markup language such as, for example, XML (Extensible Markup language), HTML (Hyper Text Markup Language), or the like.

The data storage means 111 is constituted by, for example, a magnetic disc, an optical disc, a semiconductor memory, and the like, and adapted to store therein the data sorted by the data sorting means 110. The center control means 112 is operative to read the data stored in the data storage means 111.

The description hereinlater will be directed to a construction of and a sorting operation carried out on a representative example of the contents data transmitted by the information center 102.

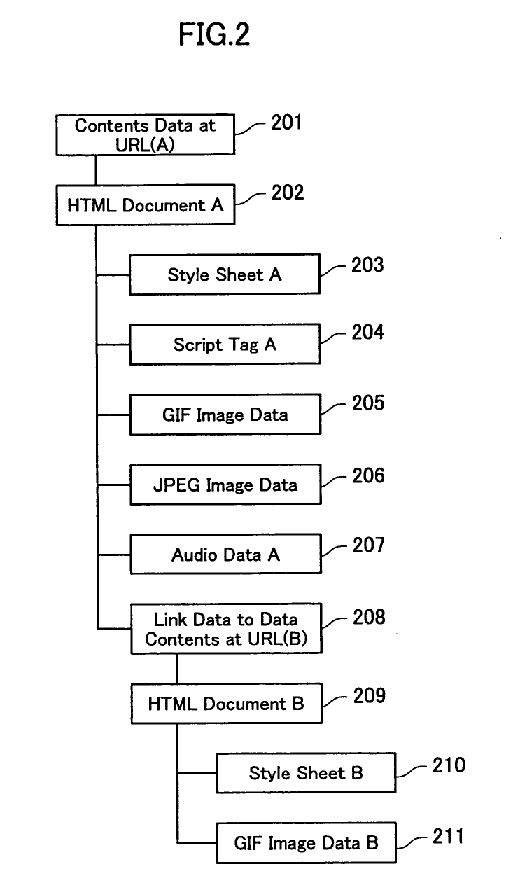

The word “URL (Uniform Resource Locator)” appearing in FIG. 2 is intended to mean a global address of documents and other resources on the World Wide Web. The contents data located at an URL (A) and the contents data located at an URL (B) respectively include an HTML document A202 and an HTML document B209 as will be clearly seen from FIG. 2.

The HTML document A202 includes a style sheet A 203 describing an attribute of the HTML document A202 such as, for example, a font, a color, a background, a text, a box, and the like, and a script tag A 204 to be carried out by the CPU to implement various functions and calculations when, for example, an activation button is pressed on the HTML document A202. The HTML document A202 further includes GIF image data A 205 created in the GIF (Graphics Interchange Format) format, JPEG image data A206 created in conformance with the JPEG (Joint Photographic Coding Expert Group) standard, audio data A 207, and link data 208 for specifying a destination link to the contents data located at an URL (B). The style sheet A 203 is described in conformance with the CSS (Cascading Style Sheets) specification. The script tag A 204 is described in, for example, a Java™ Script language.

The contents data located at the URL (B) specified by the link data 208 includes the HTML document B209. The HTML document B209 includes a style sheet B 210 describing an attribute of the HTML document B209 such as, for example, a font, a color, a background, a text, a box, and the like, and GIF image data B 211 created in the GIF format.

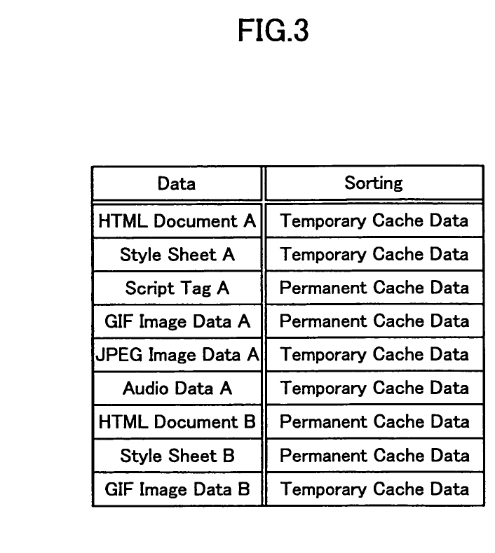

FIG. 3 shows an example of the data sorting table indicative of the data sorted from the contents data shown in FIG. 2. The data likely to be updated is sorted to the temporary cache data and the data unlikely to be updated is sorted to the permanent cache data as will be clearly seen from FIG. 3. The data sorting table is described with, for example, XML, and stored in the data storage means 111. Here, the data likely to be updated is, for example, HTML document data frequently overwritten, and the data unlikely to be updated is, for example, GIF image data indicative of a button displayed on the HTML document such as, for example, a “Previous Page” button, a “Next Page” button, or the like.

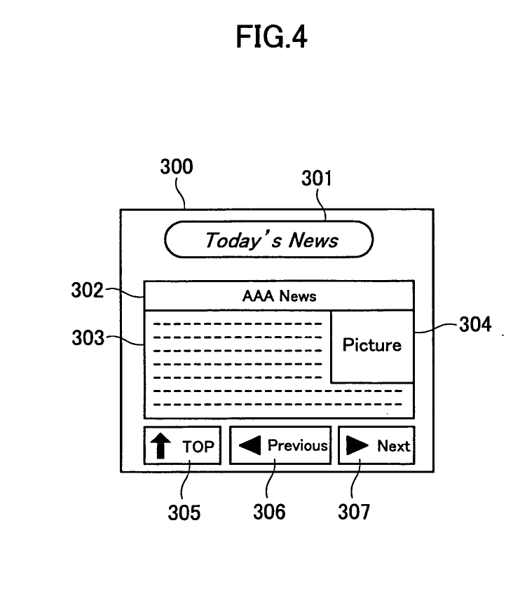

A concrete example of the sorting operation will be described hereinlater with reference to FIG. 4. The contents “Today's News” is displayed on the image display unit forming part of the output means 108 on the basis of an HTML document 300 as will be clearly seen from FIG. 4. The HTML document 300 includes GIF image data 301 indicative of the title of the contents, i.e., “Today's News”, text data 302 indicative of the title of the news, i.e., “AAA News”, text data 303 indicative of contents of the news, JPEG image data 304 indicative of a picture related to the “AAA” news, GIF image data 305 indicative of a “TOP” button to be pressed when the first page of the contents is displayed, GIF image data 306 indicative of “Previous” button to be pressed when the previous page is displayed, and GIF image data 307 indicative of “Next” button to be pressed when the next page is displayed. The HTML document 300 further includes a style sheet 308 and a script tag 309, each not shown in FIG. 4. The style sheet 308 specifies an attribute of the HTML document 300 such as, for example, a font, a color, a text, a box, and the like. The script tag 309 is carried out by the CPU to implement respective functions when the “TOP” button of the GIF image data 305, the “Previous” button of the GIF image data 306, and the “Next” button of the GIF image data 307 are pressed.

As will be seen from the above description, the HTML document 300, the text data 302 indicative of the title of the news, i.e., “AAA News”, the text data 303 indicative of contents of the “AAA”news, the JPEG image data 304 indicative of the picture, and the style sheet 308 are directly related to the ever-changing latest news. This leads to the fact that the HTML document 300, the text data 302, the text data 303, the JPEG image data 304, and the style sheet 308 are likely to be updated and accordingly sorted to the temporary cache data. On th other hand, the GIF image data 301 indicative of the title of the contents, the GIF image data 305 indicative of the “TOP” button, the GIF image data 306 indicative of the “Previous” button, the GIF image data 307 indicative of the “Next” button, and the script tag 309 are related to the frame of the contents site, which is not frequently changed. This leads to the fact that the GIF image data 301, the GIF image data 305, the GIF image data 306, the GIF image data 307, and the script tag 309 are unlikely to be updated and accordingly sorted to the permanent cache data.

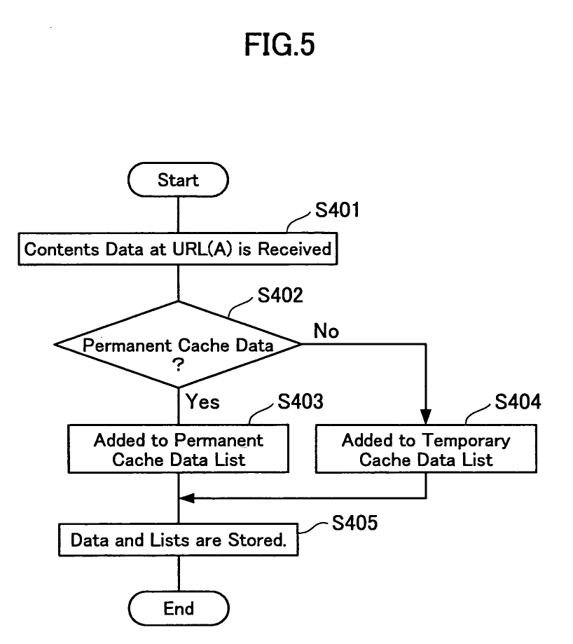

Next, the description hereinlater will be directed to the operation of the present embodiment of the data storage system 100 according to the present invention with reference to FIGS. 5 through 8. It is herein assumed that, by way of example, the contents data located at the URL (A) is sorted by the information center 102 and stored in the vehicle-mounted terminal 101.

Referring to FIG. 5, the following description will be directed to the data sorting operation performed by the information center 102. It is herein assumed the contents data located at the URL (A) is to be stored in the vehicle-mounted terminal 101.

In step S401, the center communicating means 109 is operated to receive the contents data at the URL (A). The center communicating means 109 is operated to receive the contents data at the URL (A) from the contents delivery apparatus. Step 401 goes forward to step S402, in which the data sorting means 110 is operated to sort the contents data at the URL (A) thus received into the temporary cache data and the permanent cache data.

In step S403, the data sorting means 110 is operated to add a name of the permanent cache data sorted in step S401 into a list of the permanent cache data. Step S403 goes forward to step S405. In step S404, the data sorting means 110 is operated to add a name of the temporary cache data sorted in step S401 into a list of the temporary cache data. Here, the lists of the permanent cache data and the temporary cache data collectively constitute the data sorting table. Step S404 goes forward to step S405. In step S405, the data storage means 111 is operated to store therein the permanent cache data and the temporary cache data sorted by the data sorting means 110 in step S402 and the lists of the permanent cache data and the temporary cache data respectively updated by the data sorting means 110 in steps S403 and step S404.

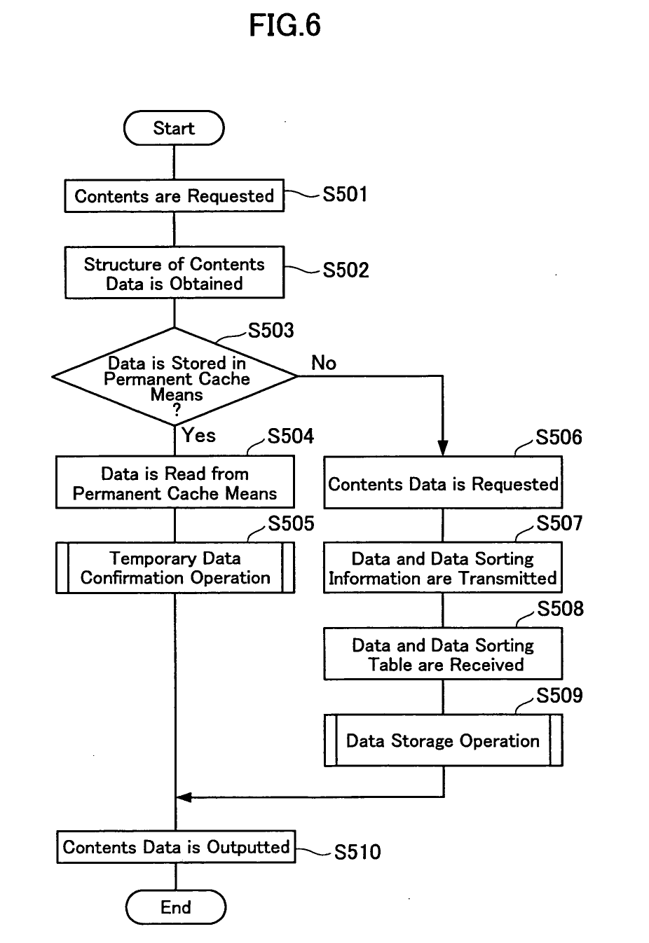

Referring to FIG. 6, the following description will be directed to the operations performed by the data storage system 100 from the time when the vehicle-mounted terminal 101 transmits a signal indicative of a request for the contents data located at the URL (A) to the information center 102 until the output means 108 outputs the contents on the basis of the contents data located at the URL (A) received from the information center 102.

In step S501, the terminal control means 107 is operated to request for contents located at the URL (A). The terminal control means 107 may be connected with, for example, a key board, a joystick, or the like, and an operator may operate the key board or the joystick to select desired contents information while observing a menu screen displayed by the image display unit forming part of the output means 108.

Step S501 goes forward to step S502, in which the terminal control means 107 is operated to obtain a structure of the contents data at the URL (A). The terminal control means 107 can obtain the structure of the contents data from information described in the HTML document A202 forming part of the contents data at the URL (A) as clearly shown in FIG. 2. This means that the terminal control means 107 may obtain the structure of the contents data from the HTML document A202 stored in the temporary cache means 104 or the permanent cache means 105. It is needless to mention that the terminal control means 107 may obtain the structure of the contents data from the information center 102.

Step S502 goes forward to step S503, in which the terminal control means 107 is operated to judge whether or not data forming part of the contents data at the URL (A) is stored in the permanent cache means 105. When it is judged in step S503 that data forming part of the contents data at the URL (A) is stored in the permanent cache means 105, step S503 goes forward to step S504, in which the terminal control means 107 is operated to read the data from the permanent cache means 105. Step S504 goes forward to step S505, in which the terminal control means 107 is operated to perform a temporary cache data confirmation operation, which will become apparent as the description proceeds. Step S505 goes forward to step S510, in which the terminal control means 107 is operated to have the output means 108 output an image and a sound on the basis of the contents data at the URL (A).

When, on the other hand, it is judged in step S503 that no data forming part of the contents data at the URL (A) is stored in the permanent cache means 105, step S503 goes forward to step S506, in which the terminal control means 107 is operated to transmit a request for the contents data located at the URL (A). Step S506 goes forward to step S507, in which the center communicating means 109 is operated to transmit the data sorting information including the contents data and the lists of the permanent cache data and the temporary cache data. Step S507 goes forward to step S508, in which the terminal communicating means 103 is operated receive the data sorting information including the contents data and the lists of the permanent cache data and the temporary cache data. Step S508 goes forward to step S509, in which the terminal control means 107 is operated to perform a data storage operation, which will become apparent as the description proceeds. Step S509 goes forward to step S510, in which the terminal control means 107 is operated to have the output means 108 output an image and a sound on the basis of the contents data at the URL (A).

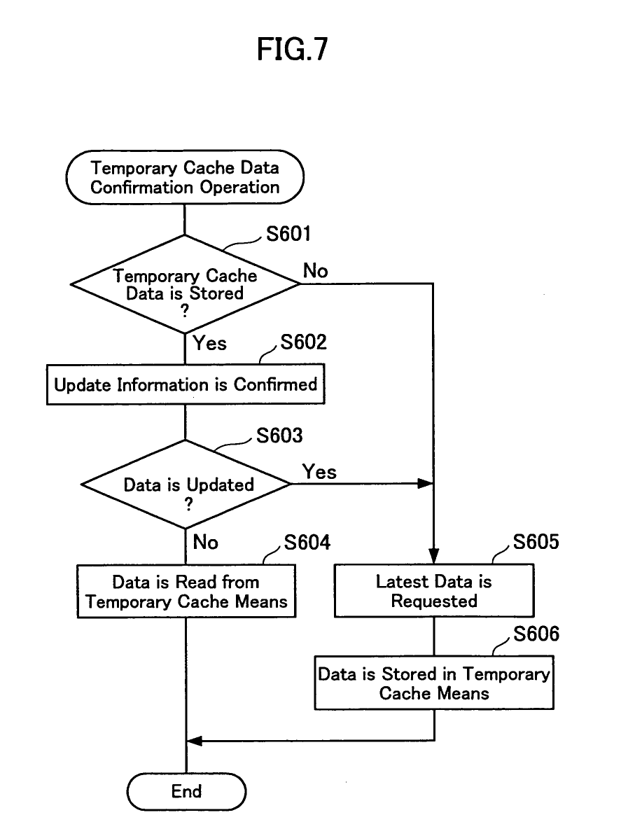

Referring to FIG. 7, the following description will be directed to the temporary cache data confirmation operation.

In step S601, the terminal control means 107 is operated to judge whether or not data forming part of the contents data at the URL (A) is stored in the temporary cache means 104. When it is judged in step S601 that data forming part of the contents data at the URL (A) is stored in the temporary cache means 104, step S601 goes forward to step S602, in which the terminal control means 107 is operated to confirm update information contained in the data stored in the temporary cache means 104. The update information is generated by the center control means 112 and indicative of whether or not the data is updated. When, on the other hand, it is judged in step S601 that data forming part of the contents data at the URL (A) is not stored in the temporary cache means 104, step S601 goes forward to step S605. Step S602 goes forward to step S603, in which the terminal control means 107 is operated to judge whether or not the data stored in the temporary cache means 104 is updated by the information center 102 on the basis of the update information. When it is judged in step S603 that the data stored in the temporary cache means 104 is not updated by the information center 102, step S603 goes forward to step S604, in which the data stored in the temporary cache means 104 is read out and the temporary cache data confirmation operation is terminated.

When, on the other hand, it is judged in step S603 that the data stored in the temporary cache means 104 is updated by the information center 102, step S603 goes forward to step S605, in which the terminal control means 107 is operated to transmit a signal indicative of a request for the latest data. Step S605 goes forward to step S606, in which the terminal control means 107 is operated to have the temporary cache means 104 store therein the latest data thus received, and the temporary cache data confirmation operation is terminated.

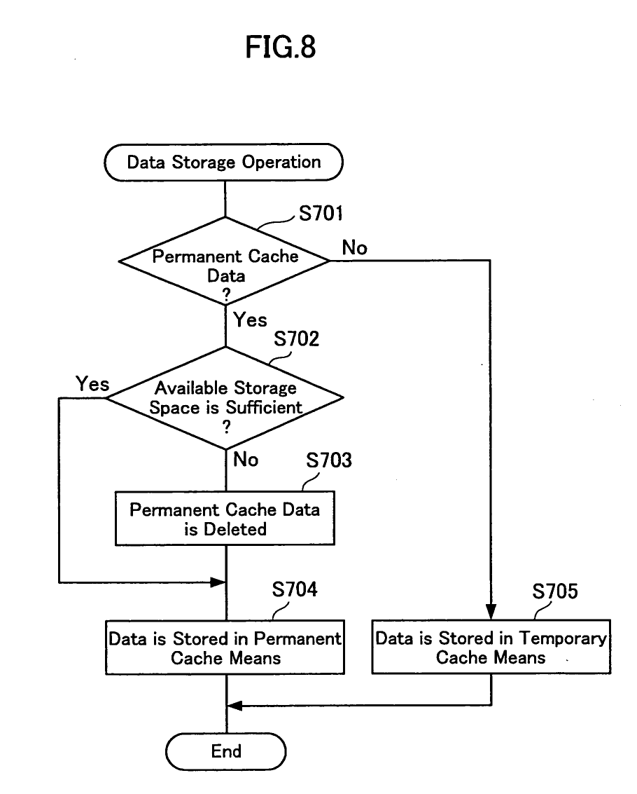

Referring to FIG. 8, the following description will be directed to the data storage operation.

In step S701, the memory selecting means 106 is operated to select from among the data the temporary cache data to be stored in the temporary cache means 104 and the permanent cache data to be stored in the permanent cache means 105 on the basis of the data sorting table. The permanent cache data selected in step S701 is not stored in the permanent cache means 105 until it is ensured that there is a sufficient storage space available in the permanent cache means 105 as follows.

Step S701 goes forward to step S702, in which the available space obtaining means 113 is operated to obtain a storage space available in the permanent cache means 105 and judge whether or not the storage space available in the permanent cache means 105 is sufficient. When it is judged in step S702 that the storage space available in the permanent cache means 105 is sufficient, step S702 goes forward to step S704. When, on the other hand, it is judged in step S702 that the storage space available in the permanent cache means 105 is not sufficient, step S702 goes forward to step S703, in which the data deletion means 114 is operated to delete one or more pieces of data stored in the permanent cache means 105 in early order of the pieces of data to ensure a sufficient storage space available in the permanent cache means 105. Step S703 goes forward to step S704, in which the permanent cache data is stored in the permanent cache means 105, and the data storage operation is terminated. While it has been described in step S703 that the one or more pieces of data are deleted from the permanent cache means 105 to ensure a sufficient storage space available in the permanent cache means 105, the data early stored in the permanent cache means 105 may be overwritten with the newly obtained permanent cache data. The temporary cache data selected in step S701 is stored in the temporary cache means 104 in step S705, and the data storage operation is terminated.

As will be seen from the above description, it is to be understood that the data storage system 100 thus constructed can reduce communication period and thus communication cost between the vehicle-mounted terminal 101 and the information center 102 contrary to the conventional data storage system resulting from the fact that the data storage system 100 thus constructed eliminates the need of confirming whether or not the data stored in the permanent cache means 105 is updated when the data stored in the permanent cache means 105 is required to be outputted.

In the present embodiment of the data storage system 100 according to the present invention, the data to be processed and stored is not limited to the contents data on an Internet site.

Further, the aforementioned step S701 constitutes a data sorting step, the aforementioned step S702 constitutes an available space obtaining step, the aforementioned step S703 constitutes a data deleting step, the aforementioned step S704 constitutes a permanent storing step, and the aforementioned step S705 constitutes a temporary storing step.

As will be seen from the foregoing description, it is to be understood that the present embodiment of the data storage system 100 according to the present invention can eliminate the need of confirming whether or not the data stored in the permanent cache means 105 is updated when the data stored in the permanent cache means 105 is required to be outputted to the output means 108 resulting from the fact that the data sorting means 110 is operative to sort the data into the temporary cache data to be stored in the temporary cache means 104 and the permanent cache data to be stored in the permanent cache means 105, thereby reducing communication period and thus communication cost.

### INDUSTRIAL APPLICABILITY OF THE PRESENT INVENTION

As will be seen from the foregoing description, it is to be understood that the present invention provides a data storage system for storing data transmitted from an information center into a terminal provided in an automotive vehicle, comprising temporary cache means for temporarily storing therein data, permanent cache means for storing therein data for a predetermined period, and data sorting means for sorting the data into temporary cache data to be stored in the temporary cache means and the permanent cache data to be stored in the permanent cache means. The data storage system according to the present invention thus constructed eliminates the need of confirming whether or not the data stored in the permanent cache means is updated when the data stored in the permanent cache means is required to be referred to, thereby reducing communication period and thus communication cost.

1. A data storage system, comprising:
a vehicle-mounted terminal mounted on a vehicle; and
an information center for transmitting data to said vehicle-mounted terminal in response to a request from said vehicle-mounted terminal, and in which
said vehicle-mounted terminal includes terminal communicating means for communicating with said information center,
temporary cache means for temporarily storing therein said data,
permanent cache means for storing therein said data for a predetermined period, and
memory selecting means for selectively having said temporary cache means and said permanent cache means store therein said data received by said terminal communicating means, and
said information center includes center communicating means for communicating with said vehicle-mounted terminal, and
data sorting means for sorting said data into temporary cache data to be stored in said temporary cache means and permanent cache data to be stored in said permanent cache means.

2. A data storage system as set forth in claim 1, in which
said terminal communicating means is operative to receive a data sorting index while receiving said data from said information center,
said memory selecting means is operative to selectively have said temporary cache means and said permanent cache means store therein said data received by said terminal communicating means on the basis of said data sorting index.

3. A data storage system as set forth in claim 1, in which
said information center further includes available space obtaining means for obtaining a storage space available in said permanent cache means.

4. A data storage system as set forth in claim 1, in which said information center further includes data deletion means for deleting said permanent cache data stored in said permanent cache means.

5. A vehicle-mounted terminal mounted on a vehicle, comprising:
terminal communicating means for communicating with an information center operative to transmit data,
temporary cache means for temporarily storing therein said data,
permanent cache means for storing therein said data for a predetermined period, and
memory selecting means for selectively having said temporary cache means and said permanent cache means store therein said data.

6. An information center comprising:
center communicating means for transmitting data to a vehicle-mounted terminal in response to a request from said vehicle-mounted terminal; and
data sorting means for sorting said data into temporary cache data to be temporarily stored in said vehicle-mounted terminal and permanent cache data to be stored for a predetermined period in said vehicle-mounted terminal.

7. A data storage method, comprising:
a data sorting step of sorting data into temporary cache data to be temporarily stored and permanent cache data to be stored for a predetermined period;
a temporary storing step of temporarily storing therein said temporary cache data; and
a permanent storing step of storing therein said permanent cache data.

8. A data storage method as set forth in claim 7, which further comprises
an available space calculating step of calculating a storage space available in permanent cache means operative to store therein said permanent cache data.

9. A data storage method as set forth in claim 7, which further comprises a data deleting step of deleting said permanent cache data stored in said permanent storing step.

10. A data storage system as set forth in claim 2, in which
said information center further includes available space obtaining means for obtaining a storage space available in said permanent cache means.

11. A data storage system as set forth in claim 2, in which said information center further includes data deletion means for deleting said permanent cache data stored in said permanent cache means.

12. A data storage system as set forth in claim 3, in which said information center further includes data deletion means for deleting said permanent cache data stored in said permanent cache means.

13. A data storage system as set forth in claim 10, in which said information center further includes data deletion means for deleting said permanent cache data stored in said permanent cache means.

14. A data storage method as set forth in claim 8, which further comprises a data deleting step of deleting said permanent cache data stored in said permanent storing step.
